(19) United States
(12) Patent Application Publication
(10) Pub. No.: US 2014/0280075 A1
(43) Pub. Date: Sep. 18, 2014

(54) MULTIDIMENSION CLUSTERS FOR DATA PARTITIONING

(71) Applicants: Wei Huang, Los Altos, CA (US); Yizheng Zhou, Cupertino, CA (US)

(72) Inventors: Wei Huang, Los Altos, CA (US); Yizheng Zhou, Cupertino, CA (US)

(73) Assignee: HEWLETT-PACKARD DEVELOPMENT COMPANY, L.P., Houston, TX (US)

(21) Appl. No.: 14/237,192

(22) PCT Filed: Aug. 24, 2012
(86) PCT No.: PCT/US2012/052289

§ 371 Date: Feb. 5, 2014

Related U.S. Application Data
(60) Provisional application No. 61/527,933, filed on Aug. 26, 2011.

(51) Int. Cl. G06F 17/30

(52) U.S. Cl. CPC G06F 17/30345; G06F 17/30477
USPC 707/722; 707/755

(57) ABSTRACT

A data storage system includes a partitioning module to partition data across multiple dimensions simultaneously. The partitioning may be based on a sizing parameter for each dimension. The partitioning module stores a cluster including the partitioned event data and metadata including attributes identifying the cluster.

### CLAIM FOR PRIORITY

The present application claims priority to U.S. Provisional application No. 61/527,933, filed on Aug. 26, 2011, which is incorporated by reference herein in its entirety.

### BACKGROUND

Database partitioning is commonly performed to create smaller pieces of the database for manageability or performance. Partitioning may include putting different rows of a database in different tables or creating tables with a fewer number of columns.

For many databases available in today's market, partitioning is static and requires the partitions to be configured before use. Also, the database administrator needs to manage partitions over time, such as adding or dropping partitions depending on the data being stored in the database.

### BRIEF DESCRIPTION OF DRAWINGS

The embodiments are described in detail in the following description with reference to the following figures. The figures illustrate examples of the embodiments.

FIG. 1 illustrates a data storage system.

FIG. 2 illustrates a security information and event management system.

FIGS. 3 and 4 illustrate methods.

FIG. 5 illustrates a computer system that may be used for the methods and systems described herein.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a data storage system performs multidimensional partitioning. The data storage system dynamically partitions data into multiple dimensions. The partitioning is performed across the multiple dimensions simultaneously. The data storage system may store event data, which is described below. The event data includes time attributes comprised of Manager Receipt Time (MRT) and Event End Time (ET). MRT is when the event is received by the storage system and ET is when the event happened. Thus, MRT is set according to the time of the system receiving the events and ET is set, for example, according to the source device that detected the event. The data storage system may perform partitioning across ET and MRT simultaneously for received event data. The partitioning may include a dynamic partitioning process. The size of the partitions can be varied allowing the partitioning to be dynamic. Also, the size of the partitions can include a fine granularity. For example, clusters may be created for multiple time-based attributes of the event data, such as ET and MRT. The size of the clusters may be set to 5 minutes, 30 minutes or other time periods less than one hour. This optimizes query performance for queries that are trying to identify events falling within a small time window.

An example of the type of data stored in the data storage system is event data, however, any type of data may be stored in the data storage system. Event data includes any data related to an activity performed on a computer device or in a computer network. The event data may be correlated and analyzed to identify security threats. Even data may be analyzed to determine if it is associated with a security threat. The activity may be associated with a user, also referred to as an actor, to identify the security threat and the cause of the security threat. Activities may include logins, logouts, sending data over a network, sending emails, accessing applications, reading or writing data, etc. A security threat may include activities determined to be indicative of suspicious or inappropriate behavior, which may be performed over a network or on systems connected to a network. A common security threat, by way of example, is a user or code attempting to gain unauthorized access to confidential information, such as social security numbers, credit card numbers, etc., over a network.

The data sources for the events may include network devices, applications or other types of data sources described below operable to provide event data that may be used to identify network security threats. Event data is data describing events. Event data may be captured in logs or messages generated by the data sources. For example, intrusion detection systems (IDSs), intrusion prevention systems (IPSs), vulnerability assessment tools, firewalls, anti-virus tools, anti-spam tools, and encryption tools may generate logs describing activities performed by the source. Event data may be provided, for example, by entries in a log file or a syslog server, alerts, alarms, network packets, emails, or notification pages.

Event data can include information about the device or application that generated the event. The event source is a network endpoint identifier (e.g., an IP address or Media Access Control (MAC) address) and/or a description of the source, possibly including information about the product's vendor and version. The time attributes, source information and other information is used to correlate events with a user and analyze events for security threats.

In one example, the data storage system performs two-phase query execution. The first phase is a fussy search that narrows down where the possible hits are. For example, metadata for each cluster is used to identify clusters that may store data for the query. The second phase is filtering, using fast scan technology to filter and find the matching events.

FIG. 1 illustrates a data storage system 100 comprising a partitioning module 122 and query manager 124. The partitioning module 122 performs multidimensional data partitioning of data, which may be event data, received from data sources 101. The data sources 101 may comprise a network device, an application or other type of system that can provide data for storage in the data storage system 100. A dimension for the multidimensional data partitioning may be an attribute for the data. The data storage 111 stores the partitioned data as clusters. The data storage 111 may include memory for performing in-memory processing and/or non-volatile storage, such as hard disks. The query manager 124 may receive queries 104 and execute the queries on the data stored in the data storage 111 to provide query results 105. The query manager 124 may use metadata for the clusters to identify clusters storing data relevant to a query. The query manager 124 may execute the search on the identified clusters. Query results 105 are results of query executions and may be presented to a user or to another module.

The partitioning module 122 performs multidimensional, data partitioning of data received from the data sources 101. The data may be event data, and the event data may include time attributes comprised of Manager Receipt Time (MRT) and Event End Time (ET). Examples of dimensions include ET and MRT. MRT is when the event data is received by the data storage system 100 and ET is when the event happened. The data storage system may perform partitioning across ET and MRT simultaneously for received event data. The partitioning may include a dynamic partitioning process. The size of the partitions can be varied allowing the partitioning to be dynamic.

FIG. 2 illustrates an environment 200 including security information and event management system (SEM) 210, according to an embodiment. The SIEM 210 processes event data, which may include real-time event processing. The SIEM 210 may process the event data to determine network-related conditions, such as network security threats. Also, the SIEM 210 is described as a security information and event management system by way of example. As indicated above, the system 210 is an information and event management system, and it may perform event data processing related to network security as an example. It is operable to perform event data processing for events not related to network security. The environment 200 includes the data sources 101 generating event data for events, which are collected by the SIEM 210 and stored in the data storage 111. The data storage 111 stores any data used by the SIEM 210 to correlate and analyze event data.

The data sources 101 may include network devices, applications or other types of data sources operable to provide event data that may be analyzed. Event data may be captured in logs or messages generated by the data sources 101. For example, intrusion detection systems (IDSs), intrusion prevention systems (IPSs), vulnerability assessment tools, firewalls, anti-virus tools, anti-spam tools, encryption tools, and business applications may generate logs describing activities performed by the data source. Event data is retrieved from the logs and stored in the data storage 111. Event data may be provided, for example, by entries in a log file or a syslog server, alerts, alarms, network packets, emails, or notification pages. The data sources 101 may send messages to the SIEM 210 including event data.

Event data can include Information about the source that generated the event and information describing the event. For example, the event data may identify the event as a user login or a credit card transaction. Other information in the event data may include when the event was received from the event source (“receipt time”). The receipt time may be a date/time stamp. The event data may describe the source, such as an event source is a network endpoint identifier (e.g., an IP address or Media Access Control (MAC) address) and/or a description of the source, possibly including information about the product's vendor and version. The data/time stamp, source information and other information may be columns in the event schema and may be used for correlation performed by the event processing engine 221. The event data may include metadata for the event, such as when it took place, where it took place, the user involved, etc.

Examples of the data sources 101 are shown in FIG. 1 as Database (DB), UNIX, App1 and App2. DB and UNIX are systems that include network devices, such as servers, and generate event data. App1 and App2 are applications that generate event data. App1 and App2 may be business applications, such as financial applications for credit card and stock transactions, IT applications, human resource applications, or any other type of applications.

Other examples of data sources 101 may include security detection and proxy systems, access and policy controls, core service logs and log consolidators, network hardware, encryption devices, and physical security. Examples of security detection and proxy systems include IDSs, IPSs, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices includes routers and switches. Examples of encryption devices include data security and integrity. Examples of physical security systems include card-key readers, biometrics, burglar alarms, and fire alarms. Other data sources may include data sources that are unrelated to network security.

The connector 202 may include code comprised of machine readable instructions that provide event data from a data source to the SIEM 210. The connector 202 may provide efficient, real-time (or near real-time) local event data capture and filtering from one or more of the data sources 101. The connector 202, for example, collects event data from event logs or messages. The collection of event data is shown as “EVENTS” describing event data from the data sources 101 that is sent to the SIEM 210. Connectors may not be used for all the data sources 101.

The SIEM 210 collects and analyzes the event data. Events can be cross-correlated with rules to create meta-events. Correlation includes, for example, discovering the relationships between events, inferring the significance of those relationships (e.g., by generating metaevents), prioritizing the events and meta-events, and providing a framework for taking action. The SIEM 210 (one embodiment of which is manifest as machine readable instructions executed by computer hardware such as a processor) enables aggregation, correlation, detection, and investigative tracking of activities. The SIEM 210 also supports response management, ad-hoc query resolution, reporting and replay for forensic analysis, and graphical visualization of network threats and activity.

The SIEM 210 may include modules that perform the functions described herein. Modules may include hardware and/or machine readable instructions. For example, the modules may include event processing engine 221, partitioning module 122, user interface 223 and query manager 124. The event processing engine 221 processes events according to rules and instructions, which may be stored in the data storage 111. The event processing engine 221, for example, correlates events in accordance with rules, instructions and/or requests. For example, a rule indicates that multiple failed logins from the same user on different machines performed simultaneously or within a short period of time is to generate an alert to a system administrator. Another rule may indicate that two credit card transactions from the same user within the same hour, but from different countries or cities, is an indication of potential fraud. The event processing engine 221 may provide the time, location, and user correlations between multiple events when applying the rules.

The user interface 223 may be used for communicating or displaying reports or notifications 220 about events and event processing to users. The user interface 223 may also be used to select the data that will be included in each chunk, which is described in further detail with respect to FIG. 2. For example, a user may select a dimension and a size parameter. For example, if the dimension is ET or MRT, the size parameter is a distance in terms of a time period from a seed. Depending on the distance (e.g., 5 minutes versus 10 minutes), the amount of data in a cluster may be smaller or larger. Thus, the user interface 223 may be used to select a distance from an ET or MRT which may control the amount of data in each cluster. Each cluster may be considered a partition. The user interface 223 may include a graphic user interface that may be web-based.

The partitioning module 122 may perform partitioning across multiple dimensions simultaneously. For example, chunks may be determined for ET and MRT simultaneously for received event data. The partitioning may include a dynamic partitioning process. The size of the partitions can be varied allowing the partitioning to be dynamic.

FIG. 3 illustrates a method 300 for dynamic data partitioning according to an embodiment. The method 300 and other methods described herein are described with respect to the data storage system 100 shown in FIG. 1 by way of example and not limitation. The methods may be performed by other systems. Also, the methods are described with respect to event data but the methods may be used for any type of data. The method 300 may be performed by the partitioning module 122 shown in FIG. 1.

At 301, event data for events is received. Event data may be received in batches from one or more of the data sources 101 or the event data may be stored and compiled into batches. The batches may be provided to the partitioning module 122 for determining clusters. The batched event data may include event data from multiple different data sources. For example, the event data may include data from different network devices.

At 302, multiple dimensions to be used for the partitioning are determined. A user may enter the dimensions. In one example, the dimensions are ET and MRT. In other examples, other dimensions may be selected. The selected dimensions may be dimensions that are for the same type of attribute. For example, ET and MRT are both time-based attributes.

At 303, a sizing parameter is determined for each dimension. A user may enter and/or modify the sizing parameter, or the sizing parameter may be calculated by a system. The sizing parameter determines the size of a cluster. For time-based attributes such as ET and MRT, examples of sizing parameters may include 1-minute, 5-minute, 30-minute, etc. The sizing parameter may be a distance from a seed. A larger distance results in a fewer number of clusters and bigger variance of aggregate ET. A smaller distance results in more clusters and a smaller variance. A function may calculate a reasonable distance that balances both factors to achieve better query performance and less storage fragmentation.

At 304, an event seed is selected. Any event may be selected as an event seed. For example, events may be received in a batch from a data source. One of the events may be randomly selected as the seed.

At 305, a cluster is determined for the received events based on the determined dimensions, sizing parameter for each dimension and the event seed. For example, the events in the received event data are split into clusters according to whether they fall into the distance from a seed. For example, if a seed has MRT and ET equal to 12:00 o'clock and a distance (e.g., sizing parameter) of 5 minutes for MRT and ET, then all events having an ET and MRT falling within the range of 12:00-12:05 are placed into the cluster. Similarly, other clusters may be created for other seeds.

The ET and MRT for an event seed may be different. For example, there may be a delay from the time the event is detected and logged on a network device and the time the data storage system 100 receives the event data from the network device. Depending on the sizing parameter determined for each dimension, the events that have similar ET and MRT may be placed in the same cluster. Furthermore, in some instances, an event may not have an ET, but it may still be included in the cluster if its MRT is within the distance to the seed.

At 306, the cluster is stored in the data storage 111. This may include storing metadata for the cluster which identifies the attributes for the duster. The attributes may include the dimensions, sizing parameters, and event seed information which identifies the dimensions of the event seed, such as the event seed's ET and MRT. The method 300 may be repeated to determine multiple different dusters for each batch.

FIG. 4 illustrates a method 400 for running a query, according to an embodiment.

At 401, the data storage system 100 receives a query of the queries 104. The query may be from a user or another system requesting data about events stored in the data storage 111.

At 402, the data storage system 100 forwards the received query to the query manager 124 for processing.

At 403, the query manager 124 identifies one or more of the stored dusters related to the query. For example, the query may identify a time range for ET or MRT that specifies the events to be retrieved. The query manager 124 compares ET and/or MRT data in the query to metadata for the dusters to identify all the clusters that may hold relevant events for the query.

At 404, the query manager 124 executes the query on the identified clusters.

At 405, the query results are provided to the user for example via the user interface 223. The query results may be provided to the event processing engine 221, for example, to correlate events in accordance with rules, instructions and/or requests.

FIG. 5 shows a computer system 500 that may be used with the embodiments described herein including the data storage system 100. The computer system 500 represents a generic platform that includes components that may be in a server or another computer system. The computer system 500 may be used as a platform for the data storage system 100. The computer system 500 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 includes at least one processor 502 that may implement or execute machine readable instructions performing some or all of the methods, functions and other processes described herein. Commands and data from the processor 502 are communicated over a communication bus 504. The computer system 500 also includes a main memory 506, such as a random access memory (RAM), where the machine readable instructions and data for the processor 502 may reside during runtime, and a secondary data storage 508, which may be non-volatile and stores machine readable instructions and data. The partitioning module 122 and the query manager 124 may comprise machine readable instructions that reside in the memory 506 during runtime. Other components of the systems described herein may be embodied as machine readable instructions that are stored in the memory 506 during runtime. The memory and data storage are examples of non-volatile computer readable mediums. The secondary data storage 508 may store data used and machine readable instructions used by the systems.

The computer system 500 may include an I/O device 510, such as a keyboard, a mouse, a display, etc. The computer system 500 may include a network interface 512 for connecting to a network. The data storage system 100 may be connected to the data sources 101 via a network and uses the network interface 512 to receive event data. Other known electronic components may be added or substituted in the computer system 500. Also, the data storage system 100 may be implemented in a distributed computing environment, such as a cloud system.

While the embodiments have been described with reference to examples, various modifications to the described embodiments may be made without departing, from the scope of the claimed embodiments.

What is claimed is:

1. A data storage system comprising:
a partitioning module executed by at least one processor to determine a plurality of dimensions, partition event data across the plurality of dimensions simultaneously based on a sizing parameter for each dimension, and store a cluster including the partitioned event data and metadata including attributes identifying the cluster from a plurality of stored clusters.

2. The data storage system of claim 1, wherein the partitioning module is to receive a batch of event data and determine a seed event from the batch of event data, and the sizing parameter for each dimension is a distance from the seed event.

3. The data storage system of claim 2, wherein the plurality of dimensions are time-based attributes of the event data, and the distance for each time-based attribute comprises a time period.

4. The data storage system of claim 3, wherein the time-based attributes comprise Manager Receipt Time (MRT) and Event End Time (ET), and the MRT for each event in the event data is when the event is received by the data storage system and the ET for each event is when the event happened.

5. The data storage system of claim 3, wherein the partitioning module is to partition the event data across the plurality of dimensions simultaneously by determining for each event whether the time-based attributes for each event in the event data are all within the distances of the event seed, and including the event in the cluster if all the time-based attributes for the event are within the distances of the event seed.

6. The data storage system of claim 1, wherein the partitioning module is to determine a plurality of clusters for received event data based on the plurality of dimensions, sizing parameters for the dimensions and events seeds for the clusters, wherein each event seed is selected from the received event data, and store the plurality of clusters and metadata for each cluster.

7. The data storage system of claim 6, comprising a query manager to receive a query, identify a cluster from the metadata for the clusters that includes data relevant to the query, and execute the query on the identified cluster.

8. The data storage system of claim 7, wherein the query manager is to provide results of the query to an event processing engine for a security information and event management system to correlate event data to identify network security threats.

9. The data storage system of claim 7, wherein the query manager is to provide results of the query via a user interface.

10. The data storage system of claim 1, comprising:
a data storage device to store the cluster and metadata; and
a network interface to receive the event data from a data source over a network.

11. A security information and event management system comprising:
a partitioning module executed by at least one processor to determine a plurality of dimensions, partition event data across the plurality of dimensions simultaneously based on a sizing parameter for each dimension, and store a cluster including the partitioned event data;
a data storage device to store a plurality of clusters and metadata for each cluster, wherein the metadata for each cluster includes attributes identifying the cluster from other stored clusters;
a query manager to receive a query, identify a cluster from the metadata for the plurality of stored clusters that includes data relevant to the query, and execute the query on the identified cluster; and
an event processing engine to correlate query results from the executed query in accordance with rules, instructions or requests to identify network security threats.

12. The security information and event management system of claim 11, wherein the partitioning module is to receive a batch of event data and determine a seed event from the batch of event data, and the sizing parameter for each dimension is a distance from the seed event.

13. The security information and event management system of claim 12, wherein the plurality of dimensions are time-based attributes of the event data, and the distance for each time-based attribute comprises a time period.

14. The security information and event management system of claim 13, wherein the partitioning module is to partition the event data across the plurality of dimensions simultaneously by determining for each event in the event data whether the time-based attributes for each event are all within the distances of the event seed, and including the event in the cluster if all the time-based attributes for the event are within the distances of the event seed.

15. A non-volatile computer readable medium including machine readable instructions executable by at least one processor to:
determine a plurality of dimensions;
partition event data across the plurality of dimensions simultaneously based on a sizing parameter for each dimension; and
store a cluster including the partitioned event data and metadata including attributes identifying the cluster from a plurality of stored clusters.
